(19) United States
(12) Patent Application Publication
(10) Pub. No.: US 2005/0001479 A1
(43) Pub. Date: Jan. 6, 2005

(54) Vehicle brake system for increasing friction coefficient

(76) Inventors: Takashi Watanabe, Nagoya-city (JP); Shoichi Masaki, Chiryu-city (JP); Moriharu Sakai, Kariya-city (JP)

Correspondence Address: POSZ & BETHARDS, PLC, 11250 ROGER BACON DRIVE, SUITE 10, RESTON, VA, 20190, US

(21) Appl. No.: 10/854,144

(22) Filed: May 27, 2004

(30) Foreign Application Priority Data
Jun. 18, 2003 (JP) 2003-173829
Mar. 29, 2004 (JP) 2004-094921

(51) Int. Cl. B60T 8/24

(52) U.S. Cl. 303/139

(57) ABSTRACT

An auxiliary braking mechanism is operated to increase a braking effect, only after it is determined whether adding the auxiliary braking mechanism during vehicle braking by a main braking mechanism will increase the braking effect. In the case where a main braking force is generated on a tire by pressing of friction material in a caliper on a disc rotor, and an approximate speed from an acceleration sensor is smaller than a predetermined value, while an outside temperature from an outside temperature sensor is within a predetermined temperature range including the freezing point, an auxiliary brake ECU estimates that water or a mixture of water and ice are present on a frozen road surface, determines that a road surface μ can be increased through operation of the auxiliary braking mechanism, and scatters sand on the road surface using a particle scattering device. Thus, it is possible to prevent lowering of the road surface μ by scattering sand on the completely frozen road surface.

### CROSS REFERENCE TO RELATED APPLICATION

This application is based upon and claims the benefit of Japanese Patent Applications No. 2003-173829 filed on Jun. 18, 2003 and No. 2004-94921 filed on Mar. 29, 2004, the content of which are incorporated herein by reference.

### FIELD OF THE INVENTION

The present invention relates to a vehicle brake system that increases a friction coefficient between a wheel and road surface by combining use of a main braking mechanism that is a normal brake device, such as a hydraulic brake device, electromechanical brake device, or regenerative brake device, with an auxiliary braking mechanism other than the main braking mechanism.

### BACKGROUND OF THE INVENTION

A sand scattering device in a vehicle, such as disclosed in Published Unexamined Utility Model Application No. 54-172439, drops sand on a road surface along a tire through operation of a switch in order to increase the friction coefficient between the tire and road surface.

However, if sand or the like is dispersed onto a dry road surface or road surface frozen at a very low temperature by the sand scattering device acting as an auxiliary braking mechanism, the friction coefficient (road surface μ) between the tire and road surface is lower than that before sand dispersal, and actually has the adverse effect of increasing the possibility of wheel slippage.

In the above related art, there are no countermeasures against cases in which the braking effect lowers or does not increase when the auxiliary braking mechanism is used.

### SUMMARY OF THE INVENTION

It is an object of the present invention to determine whether adding an auxiliary braking during vehicle braking by a main braking mechanism will increase the braking effect, and to operate an auxiliary braking mechanism only when it is determined that this addition will increase the braking effect.

According to a first aspect of the present invention, in a vehicle provided with an auxiliary braking mechanism that changes a contact state between a vehicle and a road surface, and is separate from a main braking mechanism, the auxiliary braking mechanism is operated when it is determined that operation of the auxiliary braking mechanism will increase a reaction force of the road surface on a wheel. In addition, the auxiliary braking mechanism is designed so as not to operate when it is determined that the reaction force would not increase. Thus, it is possible to prevent a vehicle slipping state or further degeneration of a vehicle slipping state. Note that the reaction force mentioned above is equivalent to a friction force F, where F=μN.

In addition, an auxiliary brake effect determining portion may determine whether a friction coefficient between the vehicle and road surface increases, instead of the reaction force of the road surface on the vehicle.

That is, in a vehicle provided with the auxiliary braking mechanism that changes the contact state between the vehicle and road surface, and is separate from the main braking mechanism, the auxiliary braking mechanism is operated when it is determined that operation of the auxiliary braking mechanism will increase the friction coefficient between the vehicle and road surface. In addition, the auxiliary braking mechanism is designed so as not to operate when it is determined that the friction coefficient would not increase. Thus, it is possible to prevent a vehicle slipping state or further degeneration of a vehicle slipping state.

Note that the area between the vehicle and road surface includes a contact portion between the road surface and a wheel (tire) of the vehicle, and an area between the road surface and portions of the vehicle other than the vehicle wheel.

In this case, when it is estimated that water is present on a traveled road surface, a determination can be made as to whether operating the auxiliary braking mechanism increases the friction coefficient between the wheel and road surface. That is, a road surface with water present generally has a friction coefficient lower than that when water is not present, thus operating the auxiliary braking mechanism in such a case can increase the friction coefficient.

In addition, when a vehicle deceleration is smaller than a deceleration threshold value, the vehicle can be assumed as in a slipping state, i.e., the friction coefficient between the wheel and road surface is small, and it can be assumed that operating the auxiliary braking mechanism will increase the friction coefficient.

When an outside temperature is within a preset temperature range including the water freezing point, it can be estimated that the road surface is in a near-frozen state, that is, the road is in a transitional state between water and ice (hereinafter, this state is referred to as a near-frozen state). In the near-frozen state, ice can be estimated as partially or completed melted, resulting in water present on the road surface. Accordingly, the friction coefficient of the road surface lowers due to the presence of water on the near-frozen road surface, and it can be assumed that operating the auxiliary braking mechanism will increase the friction coefficient.

When an electric resistance value on the traveled road surface is equal to or less than a preset resistance threshold value, it can be assumed that there is water present on the road surface which has lowered the electric resistance value. Accordingly, the friction coefficient lowers due to the presence of water on the traveled road surface, and it can be assumed that operating the auxiliary braking mechanism will increase the friction coefficient.

Furthermore, when a signal from a wiper switch is ON, that is, a wiper device is operating, the presence of water on the traveled road surface can be estimated. Accordingly, the friction coefficient lowers due to the presence of water on the traveled road surface, and it can be assumed that operating the auxiliary braking mechanism will increase the friction coefficient.

### BRIEF DESCRIPTION OF THE DRAWINGS

Other objects, features and advantages of the present invention will be understood more fully from the following detailed description made with reference to the accompanying drawings. In the drawings:

FIG. 1 is a schematic drawing showing an overall structure of a vehicle brake system according to a first embodiment of the present invention;

FIG. 2 is a flowchart showing a processing sequence of an auxiliary brake control in the first embodiment;

FIG. 3 is a schematic drawing showing an overall structure of a vehicle brake system according to a second embodiment of the present invention;

FIG. 4 is a drawing of a vehicle in which an auxiliary brake mechanism is provided in the second embodiment viewed from the front;

FIG. 5 is a flowchart showing a processing sequence of an auxiliary brake control in the second embodiment;

FIG. 6 is a schematic drawing showing an overall structure of a vehicle brake system according to a third embodiment of the present invention;

FIG. 7 is a flowchart showing a processing sequence of an auxiliary brake control in the third embodiment;

FIG. 8 is a side view of a vehicle to which a water removing device is attached, and shows a vehicle brake system according to a fourth embodiment of the present invention;

FIG. 9 is a front view of the state of water removal using the water removing device in the fourth embodiment;

FIG. 10 is a side view of a vehicle to which a water removing device is attached, and shows a vehicle brake system according to a fifth embodiment of the present invention;

FIG. 11 is a front view of the state of water removal using the water removing device in the fifth embodiment; and

FIGS. 12A and 12B are pattern diagrams showing the movement of water when a wiper portion of a water removing device shown in other embodiments is inclined toward the vehicle traveling direction.

### DETAILED DESCRIPTION OF THE PREFERRED EMBODIMENTS

The present invention will be described further with reference to various embodiments in the drawings.

Hereinafter, embodiments of the present invention will be described with reference to the accompanying drawings. It should be noted that in the following embodiments, identical or equal portions are similarly numbered in the figures.

### First Embodiment

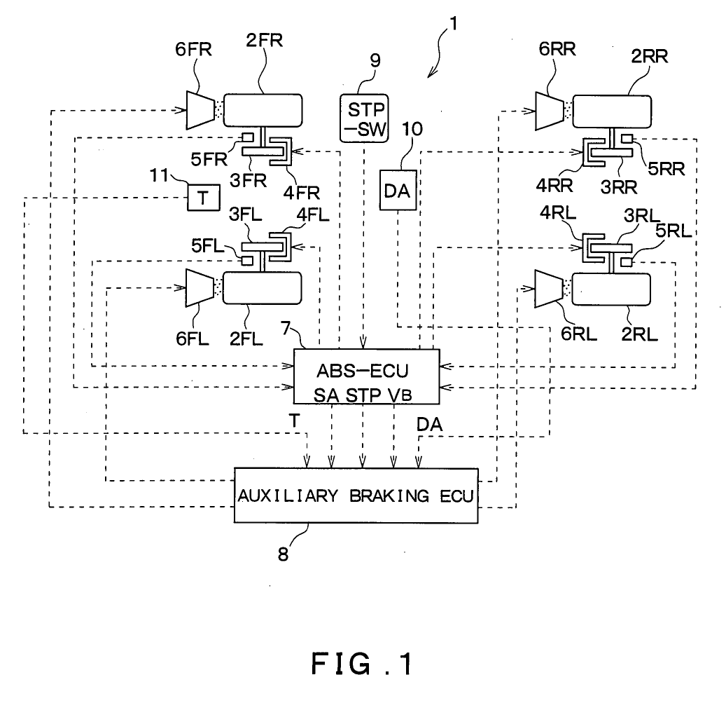

FIG. 1 is a schematic drawing showing an overall structure of a vehicle brake system according to a first embodiment of the present invention. The first embodiment is provided with an ABS control device (hereinafter referred to as ABS-ECU) 7 constructed from a microcomputer to operate an electromechanical brake device (hereinafter referred to as EMB) of each wheel. Note that a vehicle 1 is equipped with four wheels, each respectively provided with identical EMBs that are denoted as FR, FL, RR, and RL in FIG. 1. The front right wheel (FR) is described below, and descriptions of other wheels are omitted. In addition, a road surface friction coefficient that is the friction coefficient between a tire and road surface is hereinafter referred to as a road surface μ.

A disc rotor 3FR is mounted to a tire 2FR as a wheel, and integrally rotates with the tire 2FR. A caliper 4FR is provided such that the disc rotor 3FR is sandwiched therebetween. An electric motor (not shown) serving as an actuator for controlling wheel cylinder pressure is located in the caliper 4FR. The electric motor is driven by the ABS-ECU 7, and presses friction material (not shown) supported by the caliper 4FR onto the disc rotor 3FR. The rotation force of the disc rotor 3FR is suppressed by a friction force corresponding to the amount of pressing force of the friction material on the disc rotor 3FR, resulting in the generation of braking force on the tire 2FR. The electromechanical brake device (EMB), which is a main braking mechanism, is constructed from the disc rotor 3FR and the caliper 4FR.

A wheel speed sensor 5FR for detecting the rotational speed of the disc rotor 3FR, i.e. wheel speed, and a stop switch (STP-SW) 9 for detecting depression of a brake pedal (not shown) are connected to the ABS-ECU 7. In addition, the ABS-ECU 7 calculates a target braking force for each wheel in the case of normal braking operation and anti-lock brake control based upon detection signals from the wheel speed sensor 5FR and STP-SW 9, and drives each electric motor so as to generate the target braking forces.

Furthermore, a particle scattering device 6FR and an auxiliary brake ECU 8 are provided in the first embodiment as auxiliary braking mechanisms. The particle scattering device 6FR is located at a position on the vehicle front side of the tire 2FR, and has a tank for storing sand used as particulate matter and a shutter for opening and closing the tank provided at a lower portion thereof.

The auxiliary brake ECU 8 is constructed from a microcomputer, and is connected with an acceleration sensor 10 for detecting a longitudinal acceleration DA of the vehicle 1 and an outside temperature sensor 11 for measuring an outside temperature, especially an outside temperature T near the road surface. In addition, the ABS-ECU 7 supplies the auxiliary brake ECU 8 with a signal SA indicating the status of a flag that is raised during ABS braking, a stop switch signal STP-SW 9 indicating whether the brake pedal is depressed, and a signal indicating a vehicle speed VB calculated by the ABS-ECU 7 as a required amount for ABS braking.

In accordance with the signal SA indicating the status of the input flag, the stop switch signal STP, and the signal indicating the vehicle speed VB, the auxiliary brake ECU 8 determines whether the road surface μ increases in the case of operation of the auxiliary braking mechanism, which will be described later. Based upon the determination result, a drive signal is output to open or close the shutter of the particle scattering device 6FR. That is, the auxiliary brake ECU 8 constitutes an auxiliary braking effect determining portion and drive portion of the present invention.

The shutter of the particle scattering device 6FR is opened for a predetermined period according to the drive signal from the auxiliary brake ECU 8, such that sand inside the tank falls between the tire 2FR and the road surface.

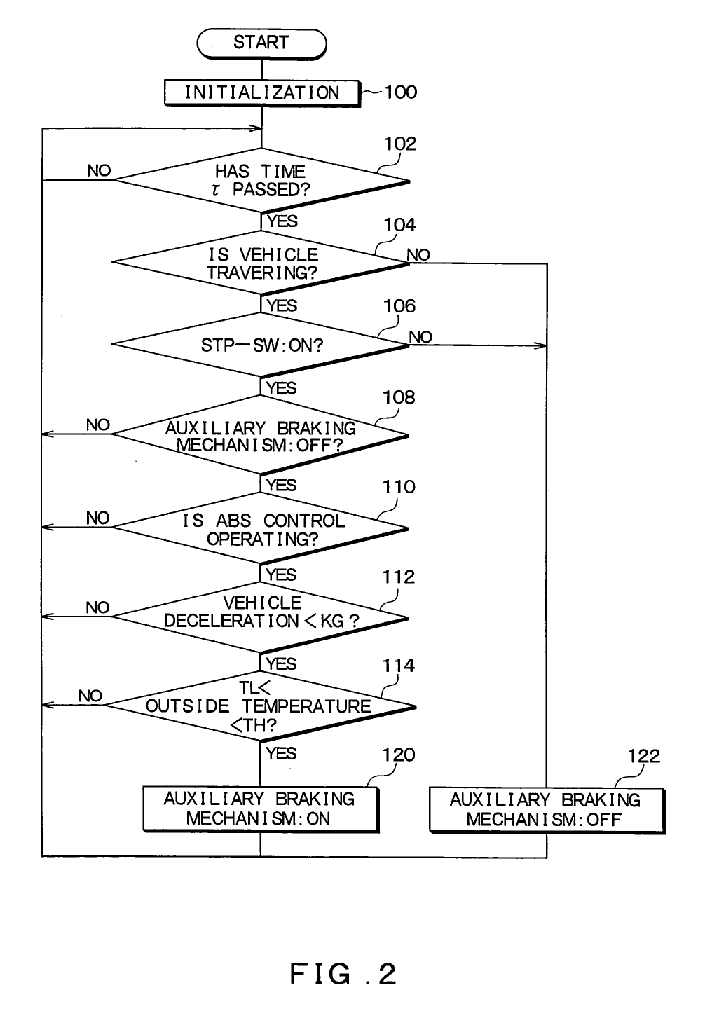

An auxiliary brake control of the vehicle brake system according to the above first embodiment will be described based upon a flowchart shown in FIG. 2. The flowchart shows a processing sequence of a program executed by the auxiliary brake ECU 8, the processing of which is initiated when an ignition switch is turned ON and repeatedly executed every predetermined time τ (e.g., τ=10 ms).

First, processing for initialization of the auxiliary brake ECU 8 is executed at 100 of the procedure. Through this initialization processing, initialization such as clearing the memory and resetting the flag in the auxiliary brake ECU 8 is performed, after which it is determined whether the time τ has passed at 102.

After the time τ has passed, at 104 it is determined whether the vehicle 1 is traveling. This determination is executed based upon the vehicle speed VB calculated by the ABS-ECU 7. If the vehicle speed VB is zero, that is, the vehicle is stopped, the procedure shifts to processing at 122, and the drive signals for the particle scattering devices 6FR to 6RL, which serve as auxiliary braking mechanisms, are turned OFF, thus closing the shutter of the particle scattering devices 6FR to 6RL.

If the vehicle speed VB is not zero at 104, that is, if it is determined that the vehicle 1 is traveling, it is then determined at 106 whether the STP-SW 9 is ON according to the stop switch signal STP. If the stop switch signal STP is OFF, the procedure shifts to processing at 122, and the drive signals for the particle scattering devices 6FR to 6RL are turned OFF; if the stop switch signal STP is ON, the procedure shifts to processing at 108.

At 108, it is determined whether the particle scattering devices 6FR to 6RL serving as auxiliary braking mechanisms are OFF, that is, whether each shutter is closed, based upon the drive signals. The procedure returns to processing at 102 if the drive signals for the particle scattering devices 6FR to 6RL are ON, and shifts to 110 when the drive signals of the particle scattering devices 6FR to 6RL are OFF. Namely, if the particle scattering devices 6FR to 6RL are all ON, i.e., each shutter is open, the particle scattering devices 6FR to 6RL will remain ON (shutters will remain open) as long as neither the determination result at 104 or 106 is NO.

At 110, it is determined whether the ABS control is operating. This determination is performed according to the status of an ABS control flag SA raised while the ABS-ECU 7 is executing ABS control. No execution of the ABS control indicates a traveling state where the wheels are gripping the road surface, regardless of whether the vehicle is in a non-braking state where EMB is not operating or a braking state generated by EMB. Thus, it is not necessary to increase the road surface μ using the particle scattering devices 6FR to 6RL as auxiliary braking mechanisms, and the procedure returns to processing at 102. However, if the ABS control is being executed, the procedure shifts to processing at 112.

At 112, it is determined based on the detection signal DA of the acceleration sensor 10 whether a vehicle deceleration DA is smaller than a preset deceleration threshold value KG (e.g., KG=0.15 (G), G: acceleration due to gravity). If the determination result is NO, that is, if the vehicle deceleration DA is equal to or greater than the deceleration threshold value KG, the road surface μ is relatively large and the necessary vehicle deceleration is obtained. Therefore, it is determined that an increase in the road surface μ using the particle scattering devices 6FR to 6RL as auxiliary braking mechanisms is not necessary, and the procedure returns to processing at 102. If the determination result at 112 is YES, that is, if the vehicle deceleration DA is smaller than the deceleration threshold value DA, the procedure next shifts to processing at 114.

At 114, it is determined whether the outside temperature T near the road surface is within a temperature range including the freezing point, TL<T<TH, based on the detection signal of the outside temperature sensor 11. Taking into account the freezing point of water (normally zero degrees Celsius) as the freezing point, the lower limit TL and the higher limit TH can be set as −5° C. and 5° C., respectively. If the outside temperature T is within this range, then the road surface has a temperature near the freezing point and is frozen or near-frozen, from which it can be assumed that water is present on the road surface. Accordingly, if the determination result at 114 is YES, that is, if the road surface μ is relatively small (determination result at 112) and the outside temperature T is within the above temperature range, then water is presumed present on the road surface.

When applying braking to tires traveling on such a road surface with water in a near-frozen state present on the road surface, water film and a mixture of water and ice (slush) forms between the tire and road surface, thus reducing the contact area between the tire and road surface, and greatly lowering the road surface μ even more than that for a completely frozen road surface. However, if particulate matter such as sand are scattered on a road surface covered with water, or where water and ice are mixed, when the outside temperature T is near the freezing point, the particulate matter break the water film between the road surface and tire to increase the contact area between the road surface and tire, thus leading to an increase in the road surface μ.

It should be noted that even if the outside temperature T is higher than the freezing point by a certain degree, if the vehicle deceleration is slow during ABS operation, it is possible that ice on the road surface is not completely melted and still remaining. Therefore, it is possible to increase the contact area between the road surface and tire by scattering sand particulate matter on the water film, thereby increasing the road surface μ.

Accordingly, if the determination result at 114 is YES, it may be determined that the road surface μ can be increased by driving the particle scattering devices 6FR to 6RL as auxiliary braking mechanisms and scattering sand particulate matter; thus, a drive signal to turn the particle scattering devices 6FR to 6RL ON is output at 120.

If the determination result at 114 is NO, the outside temperature T is a relatively high temperature equal to or greater than the upper limit TH, or a very low temperature equal to or less than the lower limit TL. When a relatively high temperature, the road surface is not frozen, and the road surface μ is relatively high even if water is present, therefore, it may be determined that scattering particulate matter will not have a large effect on increasing the road surface μ. Furthermore, if the outside temperature T is a very low temperature, water is completely frozen, and scattering particulate matter on such a state would have the adverse effect of reducing the contact area between the road surface and tire and lowering the road surface μ. Accordingly, it may be determined that driving of the particle scattering devices 6FR to 6RL as auxiliary braking mechanisms is not necessary, and driving of the particle scattering devices 6FR to 6RL may actually lower the road surface μ when the determination result at 114 is NO. Therefore, the particle scattering devices 6FR to 6RL are not turned ON, and the procedure returns to processing at 102.

As described above, in the first embodiment, when the vehicle 1 is traveling and the brake pedal is depressed while ABS is operating, i.e., when the tires are likely to lock because the road surface μ is low, it is determined that driving the auxiliary braking mechanism can have the effect of increasing the road surface μ if vehicle deceleration DA<KG and TL<outside temperature T<TH, and the particle scattering devices 6FR to 6RL are driven as auxiliary braking mechanisms so as to turn ON. Therefore, depending on the state of the road surface, the road surface μ can be increased without fail through operation of the particle scattering devices 6FR to 6RL without causing vehicle slippage, and it is also possible to avoid lowering the road surface μ through non-operation of the particle scattering devices 6FR to 6RL.

### Second Embodiment

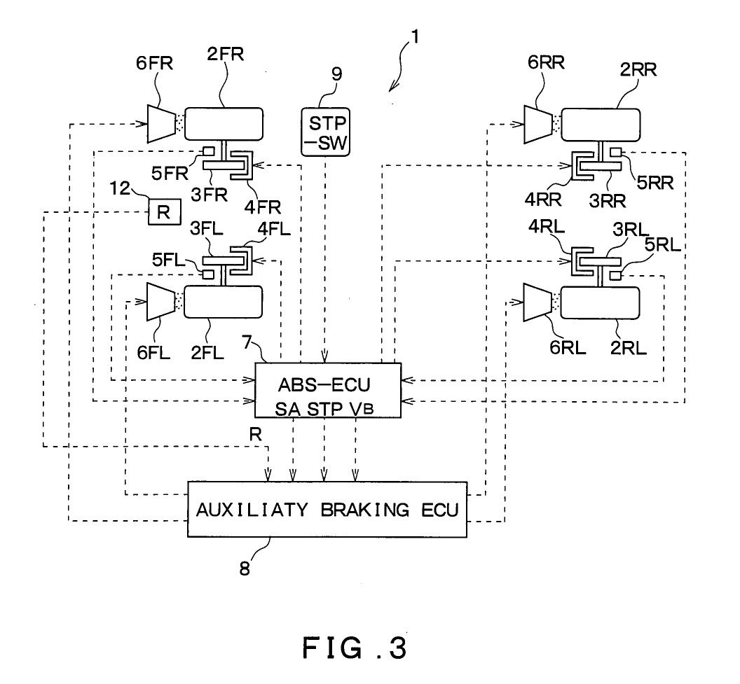

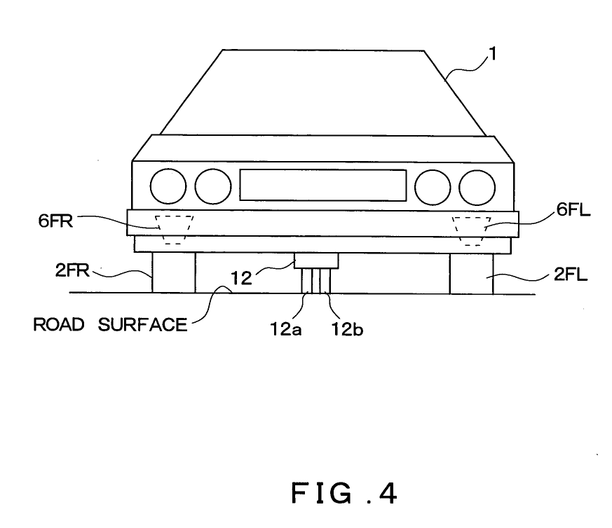

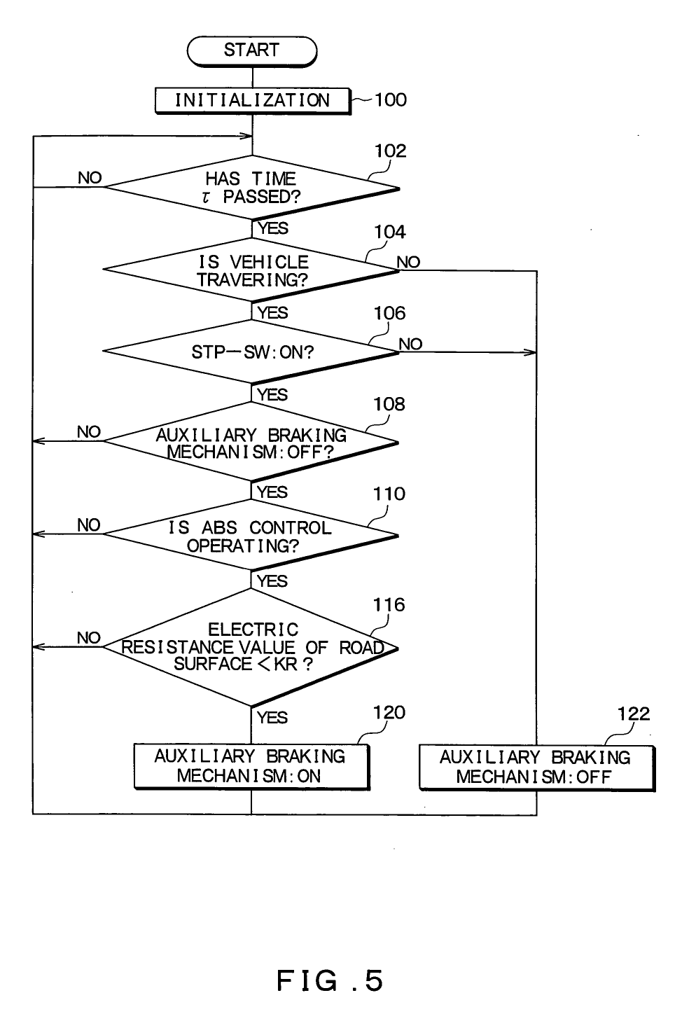

A second embodiment of the present will be described next. FIG. 3 is a schematic drawing showing an overall structure of a vehicle brake system according to the second embodiment of the present invention; FIG. 4 is a drawing of the vehicle 1 according to the second embodiment viewed from the front; and FIG. 5 is a flowchart showing processing of a program that executes an auxiliary brake control in the second embodiment. It should be noted that structures and processing similar to the above first embodiment are identically numbered and descriptions thereof are omitted.

The vehicle brake system according to the second embodiment differs from the first embodiment in that an electric resistance measuring unit 12 is provided in place of the acceleration sensor 10 and the outside temperature sensor 11.

The electric resistance measuring unit 12, as shown in FIG. 4, is provided on an under surface of the vehicle 1 between front right and left wheels 2FR, 2FL, and a detection signal thereof is supplied to the auxiliary brake ECU 8. The electric resistance measuring unit 12 is equipped with a pair of electrodes 12a, 12b provided so as to contact the road surface, and measures the electric resistance between the electrodes 12a, 12b. An electric resistance value measured by the electric resistance measuring unit 12 is a relatively low value (e.g., equal to or less than a few MΩ) when water acting as an electric conductor is present on the road surface; however, it is a high value (e.g., equal to or greater than 10 MΩ) in cases where the road surface is dry with no water present, or the road surface is frozen at a very low temperature. Accordingly, it is possible to estimate whether there is water (a water film) present on the traveled road surface based upon the size of the electric resistance value on the traveled road surface, which was measured by the electric resistance measuring unit 12 while the vehicle 1 traveled.

A program executed in the auxiliary brake ECU 8 of the second embodiment replaces procedure at 112 and 114 shown in FIG. 2 of the first embodiment with procedure at 116 shown in FIG. 5. All other processing in the program is identical to that in the first embodiment.

That is, when ABS is operating while the vehicle 1 is traveling and the brake pedal is depressed, i.e., when the tires is likely to lock because the road surface μ is low, it is determined by the electric resistance unit 12 at 116 whether an electric resistance value R of the top of the road surface is smaller than a preset resistance threshold value KR (e.g., KR=10 MΩ). If the determination result is YES, that is, when electric resistance value R<KR, the procedure shifts to processing at 120; if the determination result is NO, the procedure shifts to processing at 122.

In the second embodiment, when the electric resistance value R of the top of the road surface is smaller than the resistance threshold value KR, the presence of water or a water film on the top of the road surface is estimated, and the contact area between the road surface and tire is increased by scattering sand particulate matter on the road surface. Consequently, it is determined that the effect of increasing the road surface μ has been obtained. In cases where it is determined that the road surface μ increases due to scattering of the particulate matter, the particle scattering devices 6FR to 6RL can actually be operated to scatter particulate matter.

Even at a relatively high temperature where the road surface is not icy, if there is a water film on the road surface, the water film reduces the contact area between the road surface and tire, thereby lowering the road surface μ. In the second embodiment, the road surface μ can be increased without fail through operation of the particle scattering devices 6FR to 6RL without causing vehicle slippage on a road surface with such water film, and on a road surface with no water film, it is also possible to avoid lowering the road surface μ through non-operation of the particle scattering devices 6FR to 6RL.

### Third Embodiment

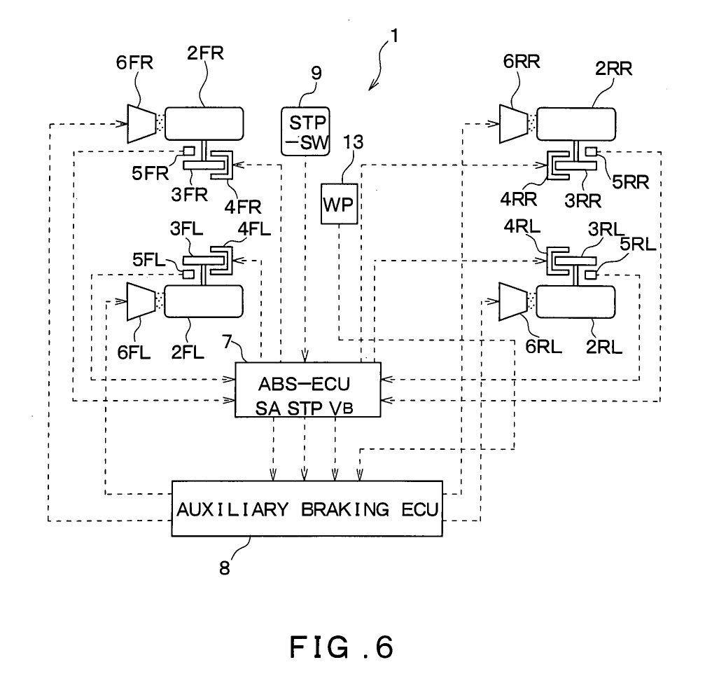

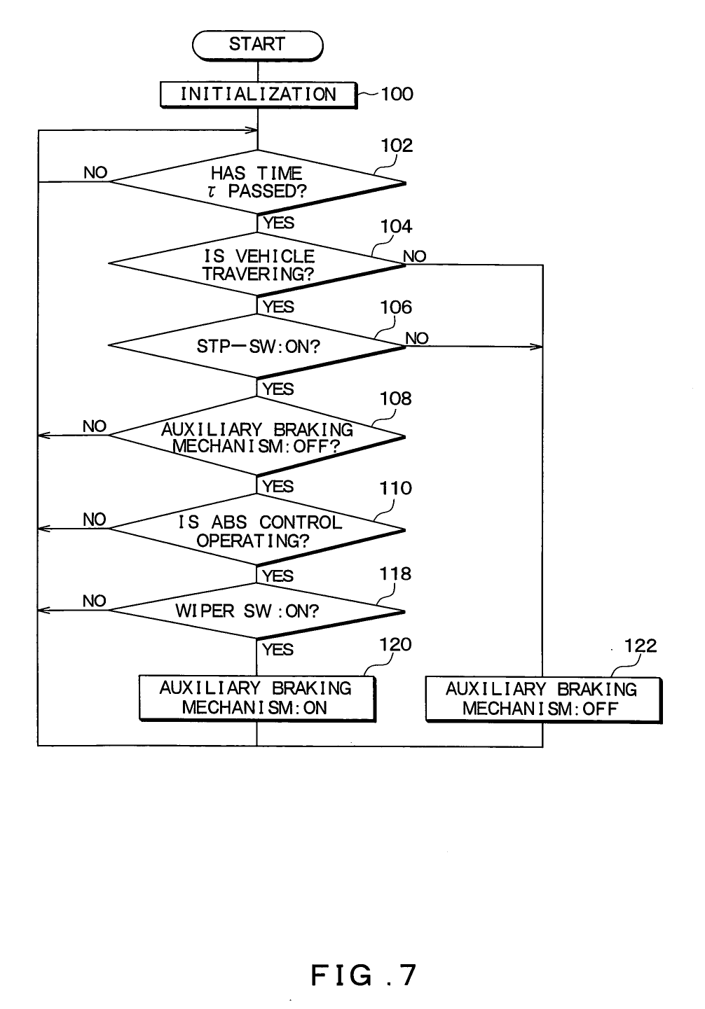

A third embodiment of the present invention will be described next. FIG. 6 is a schematic drawing showing an overall structure of a vehicle brake system according to the third embodiment of the present invention, and FIG. 7 is a flowchart showing processing of a program that executes an auxiliary brake control in the third embodiment. It should be noted that structures and processing similar to the above first and second embodiments are identically numbered and descriptions thereof are omitted.

The vehicle brake system according to the third embodiment differs from the first embodiment in that a wiper switch (wiper SW) 13 is provided in place of the acceleration sensor 10 and the outside temperature sensor 11. When a wiper device to wipe water droplets from a front windshield is automatically or manually turned ON to operate, the wiper SW 13 supplies a wiper operation signal WP to the auxiliary brake ECU 8 in response to the ON state. That is, it can be estimated from the indication of an ON state by the wiper operation signal WP that it is raining, and water or a water film is present on the road surface.

A program executed in the auxiliary brake ECU 8 of the third embodiment replaces procedure at 112 and 114 shown in FIG. 2 of the first embodiment with procedure at 118 shown in FIG. 7. All other processing in the program is identical to that in the first embodiment.

That is, when ABS is operating while the vehicle 1 is traveling and the brake pedal is depressed, i.e., when the tires is likely to lock because the road surface μ is low, if the wiper operation signal WP from the wiper SW 13 indicates an ON state at 118, the procedure shifts to processing at 120; if the wiper operation signal WP indicates an OFF state, the procedure shifts to processing at 122.

In the third embodiment, when the wiper device is operating, rain and the presence of water or a water film on the top of the road surface is estimated, and it is determined that the effect of increasing the road surface μ has been obtained by scattering sand particulate matter on the road surface. In cases where it is determined that the road surface μ increases due to scattering of the particulate matter, the particle scattering devices 6FR to 6RL can actually be operated to scatter particulate matter.

Therefore, depending on the state of the road surface, the road surface μ can be increased without fail through operation of the particle scattering devices 6FR to 6RL without causing vehicle slippage, and it is also possible to avoid lowering the road surface μ through non-operation of the particle scattering devices 6FR to 6RL.

### Fourth Embodiment

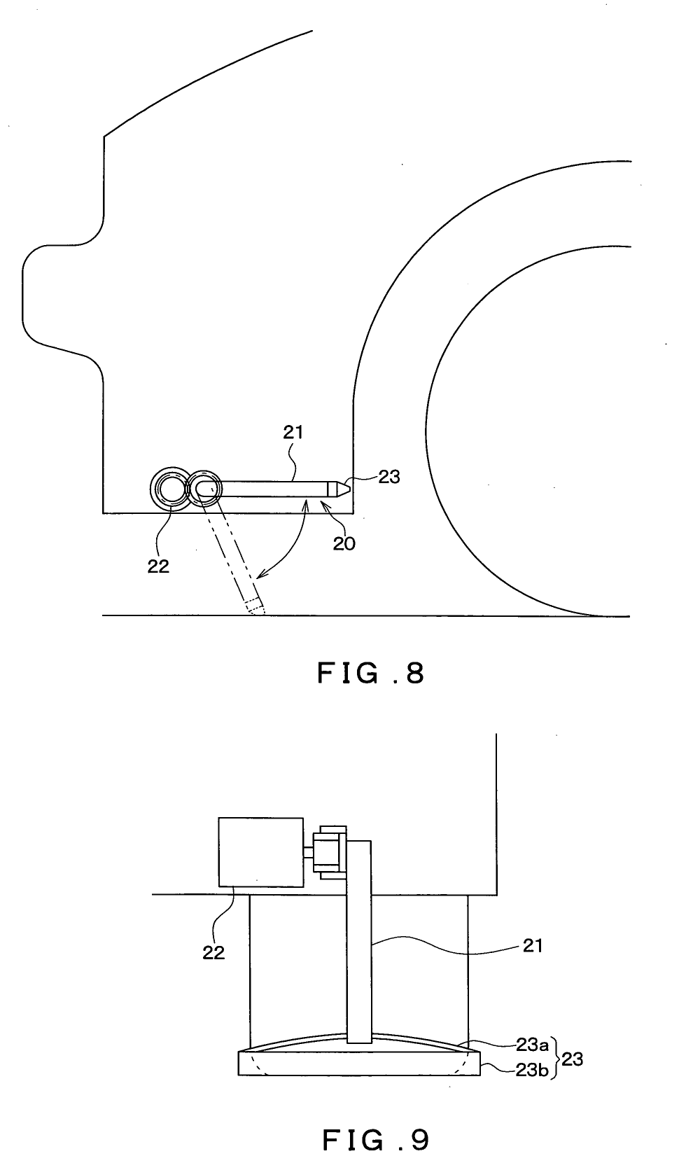

A fourth embodiment of the present invention will be described next. FIGS. 8 and 9 are pattern diagrams showing a water removing device 20 equivalent to the auxiliary braking mechanism in a vehicle brake system according to the fourth embodiment. FIG. 8 is a side view of a vehicle to which the water removing device 20 is attached, and FIG. 9 is a view of the state of water removal using the water removing device 20.

In the area in front of the vehicle wheel, the water removing device 20 removes water from the area in front of the wheel on the top of the traveled road surface. As shown in FIGS. 8 and 9, the water removing device 20 is constructed from an arm portion 21, a motor 22, and a wiper portion 23.

The arm portion 21 is equivalent to an arm mechanism and thus attached below the vehicle. The arm portion 21 is constructed such that a distal end position thereof moves to a position facing the traveled road surface and to a position at which the arm portion 21 is accommodated on a side of vehicle body of the vehicle. More specifically, an end of the arm portion 21 is rotatably supported on the side of the vehicle body of the arm portion 21, and the other end uses the end supported on the side of the vehicle body as an axis to order to allow movement on a side of the traveled road surface.

The motor 21 is a driving mechanism for driving the arm portion 21, and is structured so as to rotate the arm portion 21 around the end supported on the side of the vehicle body of the arm portion 21. The motor 21 is also driven by the auxiliary brake ECU 8 described in each of the above embodiments.

Since the wiper portion 23 is supported by the other end of the arm portion 21, and the wiper portion 23 is constructed from a spring portion 23a attached to the end of the arm portion 21 and an elastic body 23b supported by both ends of the spring portion 23a. The elastic body 23b of the wiper portion 23 has a wiper surface facing the traveled road surface, and is constructed with a width equal to or wider than the width of the wheel. Therefore, the elastic body 23b of the wiper portion 23 can remove water present on the traveled road surface by contacting or almost contacting the traveled road surface.

In the water removing device 20 as described above, for example, if the presence of water is detected on the traveled road surface by the auxiliary brake ECU 8 as shown in the first embodiment, the arm portion 21 is rotated and moved by driving of the motor 22, and the wiper portion 23 is moved on the side of the traveled road surface of the arm portion 21. Therefore, it is possible for the wiper portion 23 to remove water present on the traveled road surface, thus increasing the road surface μ on the traveled road surface.

As described above, the effect of increasing the road surface μ can be obtained even using the water removing device 20 shown in this embodiment.

### Fifth Embodiment

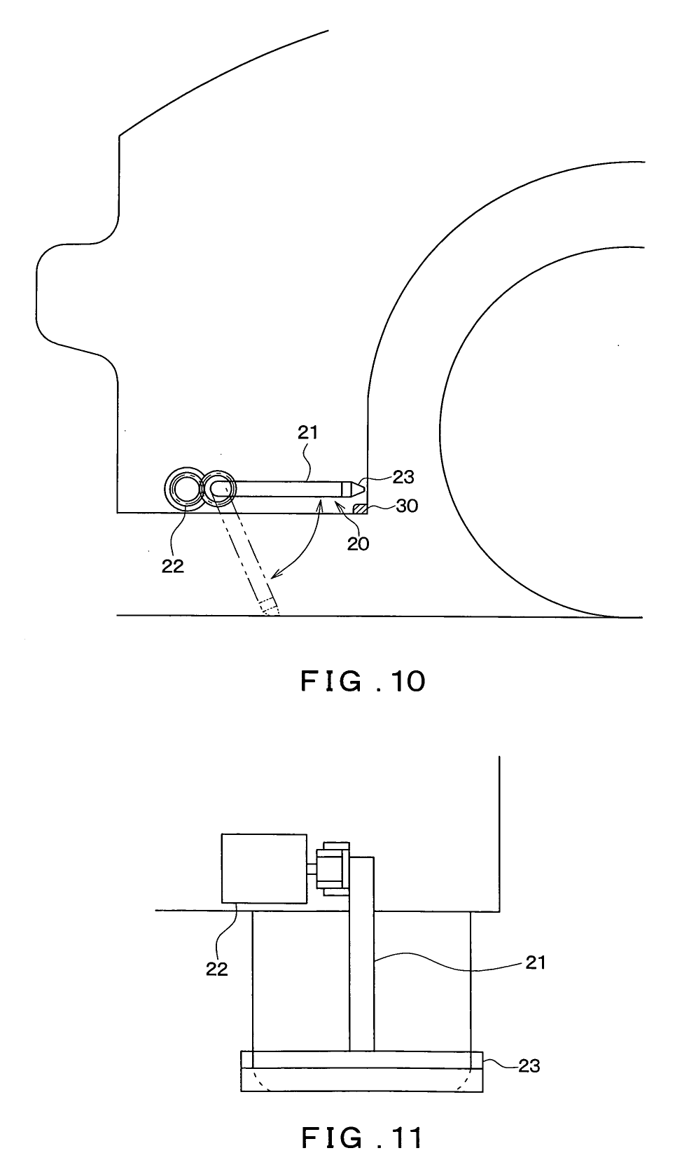

A fifth embodiment of the present invention will be described next. FIGS. 10 and 11 are pattern diagrams showing a water removing device 20 equivalent to the auxiliary braking mechanism in a vehicle brake system according to the fifth embodiment. FIG. 10 is a side view of a vehicle to which the water removing device 20 is attached, and FIG. 11 is a view of the state of water removal using the water removing device 20.

As shown in FIGS. 10 and 11, the water removing device 20 in this embodiment changes the structure of the wiper portion 23 of the fourth embodiment. The wiper portion 23 of the embodiment, as shown in the figures, for example, is constructed with a water absorbent material such as a sponge. Therefore, when the arm portion 21 is rotated by the motor 22 and the wiper portion 23 is moved toward the side of the traveled road surface, water present on the traveled road surface is absorbed by the wiper portion 23.

According to such a water removing device 20, water is not simply removed by the wiper surface of the wiper portion 23 and can also be removed through absorption by the wiper portion 23. Therefore, the wiper portion 23 is more effective in removing water present on the traveled road surface, and the road surface μ of the traveled road surface can also be increased.

Furthermore, a projection portion 30 is provided in the embodiment that serves as a water removing mechanism for removing water from the wiper portion 23 that was absorbed by the wiper portion 23. The projection portion 30 can press out water that was absorbed by the wiper portion 23 by contacting the wiper portion 23 when the wiper portion 23 is accommodated on the side of the vehicle body of the arm portion 21.

Thus, if the road surface μ needs to be increased again once the wiper portion 23 is accommodated on the side of the vehicle body of the arm portion 21 after the road surface μ was increased using the water removing device 20, by removing water from the wiper portion 23, it is possible to absorb water present on the traveled road surface with the wiper portion 23 to once again increase the road surface μ. Accordingly, if repeated increasing of the road surface μ is required, the wiper portion 23 is capable of water absorption each time.

It should be noted that water removed from the wiper portion 23 falls back to the traveled road surface. Therefore, the water should preferably fall at a point outside the area where an increase in the road surface μ is required.

### Other Embodiments

In each of the above embodiments, a determination is made, based upon respective determination conditions, regarding whether the road surface μ has been increased through operation of the particle scattering devices 6FR to 6RL acting as auxiliary braking mechanisms. In other words, since increasing the road surface μ is equivalent to increasing the reaction force of the road surface on the wheel, it can also be determined whether the reaction force of the road surface on the wheel will increase through operation of the auxiliary braking mechanism, and then operating the auxiliary braking mechanism if it is determined that the reaction force will increase.

In each of the above embodiments, examples were described in which the particle scattering devices 6FR to 6RL that scatter particulate matter such as sand were used as auxiliary braking mechanisms. However, the present invention is not limited to this, and for example, may use a device that disperses warm or hot water on a frozen road surface as the auxiliary braking mechanism to partially melt the road surface and form roughness, thus increasing the road surface μ.

Alternatively, other devices can be applied as auxiliary braking mechanisms, such as a device that stores a friction plate on a lower surface portion of the vehicle, which can be moved so as to contact the road surface during operation in order to increase the friction coefficient between the vehicle body and road surface.

Furthermore, for determining whether there is an auxiliary braking effect, the first embodiment used the acceleration sensor 10 and the outside temperature sensor 11; the second embodiment used the electric resistance measuring unit 12; and the third embodiment used the wiper SW 13. However, the present invention is not limited to this, and any combination of the above may be used to further increase the reliability of the determination of an auxiliary braking effect.

In the above fourth and fifth embodiments, as shown in FIGS. 9 and 11, examples in which the wiper portion 23 was provided in the water removing device 20 parallel to the vehicle width direction were described. However, the wiper portion 23 may be provided inclined toward the vehicle traveling direction if the arm portion 21 is positioned facing the traveled road surface.

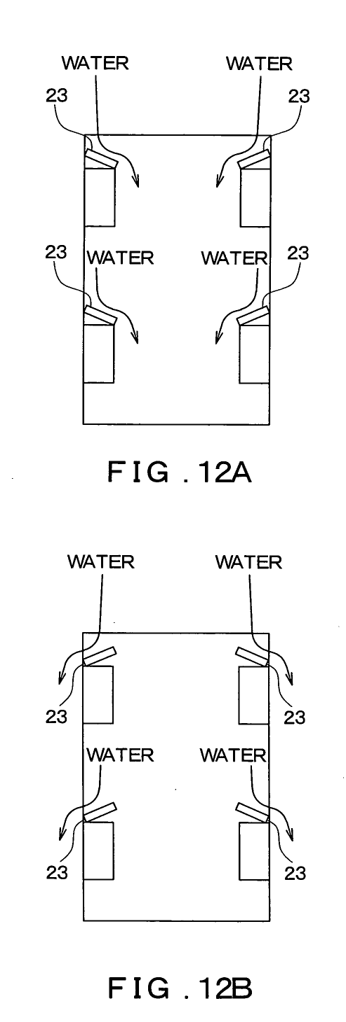

For example, as shown in FIG. 12A, if an end of the wiper portion 23 on the vehicle outer side is positioned closer to the vehicle front than the end on the vehicle inner side, then water removed by the wiper portion 23 is guided toward the vehicle inner side, thus allowing an increase of the road surface μ on the traveled road surface in contact with the wheel. Thus, it is possible to avoid splashing pedestrians with water.

In addition, as shown in FIG. 12B, if an end of the wiper portion 23 on the vehicle outer side is positioned closer to the vehicle rear than the end on the vehicle inner side, then water removed by the wiper portion 23 is guided toward the vehicle outer side, thus allowing an increase of the road surface μ on the traveled road surface in contact with the wheel. Thus, it is possible to avoid transporting removed water to the rear wheels.

Note that examples described here used the wiper portion 23 with a fixed angle, however the angle of the wiper portion 23 may have a variable structure according to the wheel state. For example, the present invention may be structured such that a wheel angle is detected from a detection signal of a steering sensor or the like, and the wiper portion 23 is disposed toward the vehicle front according to the angle thereof.

While the above description is of the preferred embodiments of the present invention, it should be appreciated that the invention may be modified, altered, or varied without deviating from the scope and fair meaning of the following claims.

1. A vehicle brake system comprising:
a main braking mechanism for generating a braking force by providing a force that suppresses a wheel rotation of each wheel on a vehicle;
an auxiliary braking mechanism mounted in the vehicle for performing an operation that changes a contact state between the vehicle and a road surface according to a drive signal;
an auxiliary brake effect determining portion for determining whether a reaction force from the road surface on the wheel will increase through operation of the auxiliary braking mechanism; and
a drive portion for outputting the drive signal to the auxiliary braking mechanism if it is determined that the reaction force will increase.

2. A vehicle brake system comprising:
a main braking mechanism for generating a braking force by providing a force that suppresses a wheel rotation of each wheel on a vehicle;
an auxiliary braking mechanism mounted in the vehicle for performing an operation that changes a contact state between the vehicle and a road surface according to a drive signal;
an auxiliary brake effect determining portion for determining whether a friction coefficient between the vehicle and road surface will increase through operation of the auxiliary braking mechanism; and
a drive portion for outputting the drive signal to the auxiliary braking mechanism if it is determined that the friction coefficient will increase.

3. The vehicle brake system according to claim 2, wherein the vehicle is provided with an anti-lock brake control device, and
the auxiliary brake effect determining portion determines whether the friction coefficient will increase through operation of the auxiliary braking mechanism during operation of the anti-lock control device.

4. The vehicle brake system according to claim 2, wherein the auxiliary braking mechanism is a particle scattering device that scatters particulate matter between the wheel and road surface.

5. The vehicle brake system according to claim 2, wherein the auxiliary brake effect determining portion estimates whether water is present on a traveled road surface, and determines that the friction coefficient is increased if it is estimated according to the estimation result that water is present on the traveled road surface.

6. The vehicle brake system according to claim 2, further comprising:
a vehicle deceleration detecting mechanism for detecting a vehicle deceleration of the vehicle, wherein
the auxiliary brake effect determining portion determines that the friction coefficient is increased if the vehicle deceleration is smaller than a preset deceleration threshold value.

7. The vehicle brake system according to claim 2, further comprising:
an outside temperature sensor for measuring an outside temperature of the vehicle, wherein
the auxiliary brake effect determining portion determines that the friction coefficient is increased if the outside temperature is within a preset temperature range including the freezing point.

8. The vehicle brake system according to claim 2, further comprising:
an electric resistance measuring unit for measuring an electric resistance value on a traveled road surface by the vehicle, wherein
the auxiliary brake effect determining portion determines that the friction coefficient is increased if the electric resistance value is equal to or less than a preset resistance threshold value.

9. The vehicle brake system according to claim 2, further comprising:
a wiper switch for detecting an operating state of a wiper device that wipes a windshield of the vehicle, wherein
the auxiliary brake effect determining portion determines that the friction coefficient is increased if the wiper device is in an operating state.

10. The vehicle brake system according to claim 5, wherein the auxiliary braking mechanism is a water removing mechanism that, in an area in front of the vehicle wheel, removes water from the area in front of the wheel on the top of the traveled road surface.

11. The vehicle brake system according to claim 10, wherein the water removing mechanism comprises:
an arm mechanism which is attached below the vehicle and structured such that an end thereof moves to a position facing the traveled road surface, and a position at which the arm portion is accommodated on a side of a vehicle body of the vehicle;
a drive mechanism for moving the arm mechanism to the position facing the traveled road surface, and the position at which the arm portion is accommodated on the side of the vehicle body of the vehicle; and
a wiper mechanism supported at a distal end position of the arm mechanism, and including a wiper surface facing the traveled road surface.

12. The vehicle brake system according to claim 11, wherein the wiper mechanism is structured providing a water absorbent material for absorbing water on the traveled road surface.

13. The vehicle brake system according to claim 12, wherein a water removing mechanism for removing water absorbed by the water absorbent material from the water absorbent material, when the arm mechanism is moved to the position at which it is accommodated on the side of the vehicle body, is provided on the vehicle.

14. The vehicle brake system according to claim 11, wherein the wiper mechanism is constructed with a width equal to or wider than the width of the wheel, is inclined toward a traveling direction of the vehicle when the arm mechanism is positioned facing the traveled road surface.
